(19) United States
(12) Patent Application Publication
(10) Pub. No.: US 2022/0016546 A1
(43) Pub. Date: Jan. 20, 2022

(54) METHOD AND DEVICE FOR CONTINUOUS COUNTERCURRENT TRANSFER OF MATERIAL BETWEEN TWO FLUID PHASES

(71) Applicants: INSTITUT NATIONAL POLYTECHNIQUE DE TOULOUSE, Toulouse Cedex 4 (FR); UNIVERSITE DE NANTES, Nantes Cedex 1 (FR); CENTRE NATIONAL DE LA RECHERCHE SCIENTIFIQUE, Paris Cedex 16 (FR)

(72) Inventors: Jean-Stéphane CONDORET, Toulouse (FR); Philippe DESTRAC, Toulouse (FR); Christophe GOURDON, Toulouse (FR); Jack LEGRAND, Saint-Nazaire (FR); Luc MARCHAL, Saint-Nazaire (FR)

(21) Appl. No.: 17/294,010

(22) PCT Filed: Nov. 14, 2019
(86) PCT No.: PCT/FR2019/052711

§ 371 Date: May 14, 2021

(30) Foreign Application Priority Data
Nov. 14, 2018 (FR) 1860505

(51) Int. Cl. B01D 11/04; B01D 15/18

(52) U.S. Cl. CPC B01D 11/048; B01D 15/1892; B01D 15/1807; B01D 11/0488; B01D 11/0407; B01D 11/0484; B01D 15/1871

(57) ABSTRACT

A method for continuous exchange of material includes countercurrent contacting of a first fluid phase and a second fluid phase that are not completely miscible. The contacting is carried out in a single centrifugal partition chromatography (CPC) apparatus into which only the first and second fluid phases introduced. The apparatus includes a plurality of cells, each with a stationary phase immobilized and a mobile phase passing through the stationary phase. The following steps are carried out successively: a) the mobile phase is formed by the first fluid phase, and the stationary phase immobilized in the cells is formed by the second fluid phase; b) the mobile phase is formed by the second fluid phase, and the stationary phase immobilized in the cells is formed by the first fluid phase; c) repetition of the succession of steps a) and b) each step being carried out immediately after the preceding step.

### TECHNICAL FIELD

The invention relates to a method for the continuous countercurrent transfer, exchange, of material between two fluid phases.

More specifically, the invention relates to a method for the continuous countercurrent transfer, exchange, of material between a first fluid phase and a second fluid phase.

These two phases must not be fully, completely, miscible. In other words, they are non-fully, non-completely miscible.

According to the invention, this method of transfer, exchange of material uses a single apparatus which is a Centrifugal Partition Chromatography (CPC) apparatus or an apparatus having similar mechanical and hydraulic operation to a Centrifugal Partition Chromatography apparatus.

The invention also relates to the device for carrying out this method.

The technical field of the invention may generally be defined as the exchange of material between two fluid phases, i.e. two phases which are not solids.

In particular, these fluid phases may each independently be selected from among all fluid phases such as liquid, gas and supercritical phases.

In the event that both phases are liquid phases, the exchange of material may be a liquid/liquid extraction operation during which a chemical compound, called solute, in a liquid phase called feed phase is transferred to another liquid phase called solvent phase. The obtained feed phase, thus depleted in solute, is called raffinate. The obtained solvent phase, enriched in solute, is called extract.

Ideally, the two initial liquid phases are immiscible, but may be partially miscible.

It is recalled that two concepts are of importance for liquid/liquid extraction:

NTP (Number of Theoretical Plates). Schematically, it is a measurement of the separative capacity of an extraction apparatus. NTP is therefore synonymous with yield of solute extraction or raffinate purification.

Countercurrent. The countercurrent consists in circulating the feed phase containing the solute and the solvent phase in countercurrent to each other. It is a contact mode that maximizes the potential for material exchange between the two fluid phases, and hence also the yield of solute extraction or raffinate purification, for a given solvent flow rate.

### STATE OF THE PRIOR ART

Numerous liquid/liquid extraction technologies are implemented over a wide range of sectors such as heavy chemistry, fine chemistry, pharmaceuticals, nuclear industry, and hydrometallurgy.

Methods using mixer-settlers are the oldest extraction technology, with for example the “Edeleanu” method (described in U.S. Pat. No. 1,651,328 (for crude oil refining.

These apparatuses comprise a stirring zone for the two liquid phases (step at which the solute passes from one liquid phase to the other) and a gravity settler (step at which the two liquid phases are separated). These apparatuses are simple in design and robust, and easy to scale up. It is sufficient to multiply the number of apparatuses to obtain high TPN values. It is also sufficient to increase the stirring and settling volumes so that it is possible to treat high even very high flow rates, for example higher than 150 m³/h. Such flow rates are typically found in the mining industry. However, this multiplication of the number of apparatuses results in high investment costs and floor space requirements, large immobilized volumes of feed and solvent phases, as well as high maintenance costs due especially to the large number of pumps and piping. On the other hand, the proper operation of this type of equipment requires that the liquid phases involved have sufficient difference in density, of the order of 50 kg/m³ or higher, and/or that they do not have a tendency to emulsify, since mechanical separation of the phases is achieved under the action of the force of Earth's gravity.

One drawback of this technology is also the long time it takes to reach steady-state operation.

To increase the compactness of these methods, methods have been proposed using equipment of countercurrent gravity column type.

These columns allow the treatment of feed phase flow rates ranging from 20 L/h to 50 m³/h whilst allowing a relatively high TPN value to be reached, which may exceed ten or so theoretical plates.

However, it still remains difficult to treat low flow rates (for example, less than 20-30 L/h) with this technology, especially because of wall effects.

The proper operation of this type of equipment also requires that the liquid phases involved should have sufficient difference in density, of the order of 50 kg/m³ and higher, and/or that the involved liquid phases do not have a tendency to emulsify since mechanical separation of the phases is achieved under the action of the force of Earth's gravity.

One drawback of this technology is also the long time it takes to reach steady-state operation.

Other extraction apparatuses using centrifugal force have therefore been developed for liquid phases that are difficult to separate. These apparatuses also have the advantage that they can be used for a wide range of feed rates (from 20 L/h to several m³/h).

However, these apparatuses do not allow NTP values as high as columns to be obtained, unless several centrifugal apparatuses are used operating in countercurrent mode.

It is therefore apparent, in the light of the above, that there is a need for a method for exchange of material between two fluid phases, such as a liquid/liquid extraction method, which does not have the defects, limitations, and disadvantages of the prior art methods as described above, and which solves the problems raised by these methods.

In particular, there is a need for a method which provides for a large number of theoretical plates (NTP: typically higher than 10) over a wide range of flow rates, including feed phase flow rates of less than 30 L/h or even 20 L/h.

There is also a need for a method that can be implemented in a single apparatus of compact design, whilst achieving high NTP values.

There is a further need for such a method which allows highly efficient treatment of all types of liquid phases or others, and in particular of so-called “difficult” liquid phases, i.e. phases with small differences in density, or which exhibit emulsifying or foaming phenomena.

There is a further need for such method which is easy to implement, i.e. in particular with short start-up times and the lowest possible feed and solvent volumes immobilized in the apparatus.

Finally, there is a need for such a method which has limited investment and operating costs.

Additionally, and fully independently, in a different technical field, namely the technical field of chromatography, the technology called Centrifugal Partition Chromatography (CPC) is known.

Centrifugal Partition Chromatography (CPC) technology is derived from Countercurrent Centrifugal Chromatography (CCC) developed by Y. ITO in the 1960s and 1970s. The first CCC apparatuses were originally built in Japan to conduct particle size segregation of suspended solids and solute separation in a solvent system. These early CCC apparatuses operated on the principle of a variable gravitational field produced by a two-axis gyratory mechanism but without truly performing countercurrent flows of the two liquid phases.

In 1982, the first prototype of a CPC apparatus (centrifugal partition chromatograph) was built. CPC apparatuses differ from the early CCC apparatuses in that they use a constant gravitational field, created by a single axis of rotation.

A CPC apparatus is in the form of a stack of discs or cartridges in which several tens or hundreds of cells are etched and connected together by channels of small diameter. These cells may be of cylindrical, rectangular, spherical or ovoid shape. They may be symmetrical or asymmetrical with respect to the plane of rotation of the CPC apparatus.

It has also been proposed to divide each cell into two cells of smaller volume.

It is inside these cells that close contact takes place between the two liquid phases followed by their separation, under the effect of the centrifugal field.

It is added that apparatuses with a vertical rotation axis are the most widespread, but apparatuses also exist having a horizontal rotation axis.

A CPC column allows a chromatographic type separation to be achieved between solutes initially contained in a mobile liquid phase. This mobile liquid phase is circulated through the CPC device by means of a circulation pump via channels connecting together all the cells of the CPC column. The stationary phase is immobilised in the cells by the centrifugal force field and by the density difference between the two phases. The mobile phase is therefore injected into the cells wherein this stationary phase is already present. The solutes then divide themselves between the mobile phase and the stationary phase. The mobile phase passes successively from cell to cell.

The differences in the values of the partition constants of the solutes between the two liquid phases allow separation of these solutes by chromatographic effect, i.e. their spatial and temporal concentrations come to differ.

The high number of cells (several hundred) provides for a true chromatographic separation process of the solutes. This is the same principle as with high performance liquid chromatography (HPLC), with the exception that the stationary phase is no longer solid but liquid in the case of CPC.

The interest of CPC apparatuses is that they offer a low-cost stationary phase having adjustable physicochemical properties (polarity, affinity for solutes, density, viscosity, interfacial tension) and, more especially, they can be easily fed into and drawn off from the CPC column.

With a two-phase liquid system, there are two elution modes in CPC. In the so-called descending mode, the stationary phase is the light phase, which is positioned towards the rotation axis of the device. The mobile phase, which is therefore the heavy phase, is propelled radially by centrifugal force and moves away from the axis of rotation. Under the action of the centrifugal gravitational field, the stationary phase is held within the cells while the mobile phase passes therethrough in the form of droplets or jets. The circulation flow rate (and incompressibility of the liquids) then forces the mobile phase to move into the channels to feed the next cell. In the so-called ascending mode, the stationary phase is the heavy phase and the mobile phase is the light phase which is eluted in each cell in a centripetal movement. The changeover from one elution mode to the other is achieved by pumping the other of the two phases through the other end of the column.

FIGS. 1 and 2 illustrate the principle of Centrifugal Partition Chromatography, whereby a liquid stationary phase is immobilised in the cells by centrifugal force and a liquid mobile phase percolates through this stationary phase.

FIG. 1 shows two cells (11, 12) of a CPC device operating in ascending mode.

In this ascending mode, the mobile phase, which is the light phase (13), e.g. a solute-laden organic phase, is pumped into the cells from a reservoir (14), against the centrifugal force field (arrow g), and it flows through the stationary phase which is the heavy phase (15), e.g. an aqueous phase, which is immobilised in the cells (11, 12).

FIG. 2 shows two cells (11, 12) of a CPC device operating in descending mode.

In this descending mode, the mobile phase which is the heavy phase (15), e.g. an aqueous phase, passes through the stationary phase which is the light phase (13), in the direction of the centrifugal force field (arrow g). In the column (11), the saturated solvent is expelled and replaced by the solvent of cell (12).

Document FR-A1-2856933 relates to a method for separating the constituents of a feedstock in liquid solution of at least two constituents (A, B) having different partition coefficients, which means that they are driven at unequal velocities respectively by a light solvent and a heavier solvent, in a system comprising at least one centrifugal liquid-liquid chromatographic column formed by interconnecting in series at least one set of separation cells.

This method comprises the following steps:
injecting the feedstock at an intermediate point of said sets of cells; and
performing alternating cycles of two phases, with a first phase during a first time interval (t1) at which lighter solvent is injected through a first end of the device and a first component is collected at a second end of the device, and a second phase during a second time interval (t2) at which heavier solvent is injected through the second end of the device and a second component is collected at the first end.

It is noted that the method of this document is characterized by continuous injection of A, B at a point between the ends of the chromatographic column, by eluting alternately in the two descending and ascending modes at an operator-defined frequency, by the collection of fractions at both ends of the chromatographic column alternately at operator-defined frequency ϕ, and finally by simultaneous filling of the chromatographic column with both phases at an operator-defined ratio.

The article by Johannes Goll et al, Journal of Chromatography A, 128 (2013), 59-68 relates to a so-called sequential Centrifugal Partition Chromatography (sCPC)method, which is a cyclic liquid-liquid chromatographic method without solid support, in which a feedstock consisting of a mixture is separated into two product streams that are successively collected.

In the “Introduction” section of this document by Johannes Goll, the authors review the various known methods. They indicate that in the so-called “support-free liquid-liquid chromatography” technique (commonly referred to as «counter-current chromatography” (CCC) and “Centrifugal Partition Chromatography” (CPC)), a continuous separation of a feed mixture into two products is possible with the process design concept patented by Francois Couillard (in document FR-A1-2856933).

The principle of this process for the separation of a mixture comprising two components A and B is shown in FIG. 1 of this document by Johannes Goll.

The document by Johannes Goll indicates that the inventors of FR-A1-2856933 would have called their method: “true moving bed centrifugal partition chromatography (TMB CPC)”. But in the article by Johannes Goll, the authors prefer to call this method “sequential Centrifugal Partition Chromatography” (sCPC).

The main purpose of the study in Johannes Goll's document is to investigate the separation possibilities and limitations of sCPC, as described in FR-A1-2856933.

The method described in this document is substantially similar to the method described in FR-A1-2856933, to which explicit reference is made.

However, in this document, it is also clearly specified that use is made of two columns connected in series.

Document EP-A1-3 409 339 was filed on 29 May 2017, and published on May 12, 2018.

This document describes a method for separating mixtures of natural substances, in particular from plant extracts, using a technique of “sequential Centrifugal Partition Chromatography (sCPC)” (Abstract) and [0001].

In paragraphs [0002] to [0009], a description is given of the principle of the so-called “True Moving Bed” (TMB) method, also called “sequential Centrifugal Partition Chromatography (sCPC)”.

In paragraph [0002], it is specified that the basic document describing this technique is document WO-A1-2005/011835. This document corresponds to document FR-A1-2856933.

This method ([0003]) is characterized by the continuous switching, changeover from stationary phase to mobile phase and vice versa, which means that the dense phase or the “less dense” phase can be chosen as the mobile phase, and that this choice can be modified during a separation, this being the reason why this method is also called “sequential Centrifugal Partition Chromatography (sCPC)”.

According to paragraph [0004], an sCPC device has at least one rotor with many metal disks on which there are more than a thousand separation chambers (i.e. cells) connected in series. By means of a pump, a mobile phase is (continuously) pumped through the stationary liquid phase. Under the effect of centrifugal force and because of the difference in density, separation of the two liquid phases takes place in each chamber. As soon as the mobile liquid phase is in equilibrium with the stationary liquid phase, the sample or mixture of substances can be injected into the rotor.

According to [0006], the sample or mixture of substances is preferably injected at an intermediate point of the rotor. In another embodiment, two or more rotors may be coupled.

A schematic diagram of a cycle is shown in FIG. 1 of this document. It is noted that in this Figure, the device comprises two rotors 1 and 2 and that the feed (“Feed”) is injected, fed between these two rotors.

In paragraph [0011], it is mentioned that the state of the art describes that sCPC may be used for the purification of substances and binary mixtures (in this respect, EP-A1-3 409 339 cites Johannes GOLL et al.), but that the state of the art does not describe methods for the separation and/or purification of natural substances from plant extracts, and hence for the preparation of fractions and pure substances.

According to paragraph [0012] and claim 1 of EP-A1-3 409 339, the invention of this document therefore relates to a method for the separation and/or purification of natural substances from plant extracts, comprising at least one liquid-liquid partition chromatography step during which there is continuous changeover, switch, from the stationary phase to the mobile phase and vice versa, characterized in that one or more fractions are separated.

In Example 1, paragraph [0028] the apparatus used is a “True-Moving-Bed” (TMB) liquid-liquid chromatograph with two rotors.

This apparatus and equipment are very similar to the device and equipment used in the document by Johannes Goll.

According to paragraph [0030], the sample or mixture of substances is continuously injected, stepwise, into the two rotors, and the sample components are separated with a suitable two-phase solvent system, depending on their polarity and liquid-liquid partition coefficient K.

This document describes a method quite similar to the methods of FR-A1-2856933 and of the document by Johannes Goll, which are moreover cited in this document.

In particular, the method of this document is implemented with an equipment similar to that used in the method of the document by Johannes Goll.

It would seem that the method of EP-A1-3 409 339 only differs from the methods of FR-A1-2856933 and of the document by Johannes Goll in that it is used specifically for separating and/or purifying natural substances from plant extracts, one or more fractions or a pure product being separated.

It is the goal of the present invention inter alia to meet the aforementioned needs for a method for exchange of material between two fluid phases, such as a liquid/liquid extraction method.

### DESCRIPTION OF THE INVENTION

This goal and still others are achieved, according to the invention with a method for continuous exchange of material by countercurrent contacting of a first fluid phase and a second fluid phase, that are not fully, completely, miscible, characterized in that contacting is performed in a single apparatus, which is an apparatus of Centrifugal Partition Chromatography (CPC) apparatus type, into which only the first fluid phase and the second fluid phase are fed to the exclusion of any other phase, said apparatus comprising a plurality of cells with a stationary phase immobilised in each of the cells and a mobile phase passing through the stationary phase, and in that the following steps a), b) and c) are successively carried out:
a) Step at which the mobile phase consists of the first fluid phase, and the stationary phase immobilised in the cells consists of the second fluid phase;
b) Step at which the mobile phase consists of the second fluid phase, and the stationary phase immobilised in the cells consists of the first fluid phase;
c) Repetition of the succession of steps a) and b);
   step b) being performed immediately after step a), and step c) being performed immediately after step b).

It is to be noted that the apparatus of the Centrifugal Partition Chromatography (CPC) apparatus type could also be called a column of the Centrifugal Partition Chromatography (CPC) column type.

Basically, solely, only the two fluid phases placed in countercurrent contact are fed into the single apparatus (column) of the CPC apparatus (column) type used in the method of the invention, and no other phase such as a feed whose constituents are to be separated is further fed into the apparatus of CPC apparatus type as is the case in FR-A1-2856933 since, according to the invention, no separation is performed.

Advantageously, the apparatus (column) which is an apparatus of CPC apparatus (column) type used in the method of the invention, only comprises two inlets for feeding phases into the apparatus, namely a first inlet through which the first fluid phase is fed into the apparatus, and a second inlet through which the second fluid phase is fed into the apparatus, and if the apparatus optionally further comprises one or more other inlet(s), this inlet (these inlets) is (are) not used to feed one or more phase(s) other than the first fluid phase and the second fluid phase into the apparatus.

The first inlet is preferably located at a first end of the apparatus (column) and the second inlet is preferably located at a second end of the column. When one of these two inlets is used to feed a fluid phase, the second inlet is used to draw off a fluid phase out of the apparatus.

In general, the apparatus of CPC type used in the method of the invention, other than the two inlets for each of the fluid phases placed in contact, does not comprise any other inlet(s) in particular at an intermediate point, in particular for another phase such as a feed of which the constituents must be separated as is the case in FR-A1-2856933 since, according to the invention, no chromatographic separation is performed, but rather countercurrent extraction of a solute contained in a fluid by another fluid containing an extraction solvent is performed.

If a known, commercially available apparatus is used, then the possible, optional, other inlet(s) that this apparatus may comprise—which are generally provided for feeding another phase such as a feed to be separated in addition to the two aforementioned phases—are not used and/or are closed off.

Advantageously, the density of the first fluid phase is lower than the density of the second fluid phase, and step a) is then a step called step in ascending mode, and step b) is then a step called step in descending mode; or else, the density of the first fluid phase is greater than the density of the second fluid phase, and step a) is then a step called step in descending mode and step b) is then a step called step in ascending mode.

By apparatus of the Centrifugal Partition Chromatography (CPC) apparatus type, it is meant that this apparatus is either a conventional Centrifugal Partition Chromatography (CPC) apparatus such as a commercially available apparatus, or an apparatus having similar mechanical operation to that of a Centrifugal Partition Chromatography (CPC) apparatus, which may be an apparatus specifically designed and built to implement the method of the invention.

By not fully, completely, miscible, it is generally meant that the first fluid phase and the second fluid phase are not miscible in all proportions one in the other. Therefore, the first fluid phase and the second fluid phase may be non-miscible one in the other in all proportions, or the first fluid phase and the second fluid phase may be partially miscible one in the other.

By immediately, it is generally meant that the changeover, switch, between a step a) a and step b) or between a step b) and a step a) is very fast, instantaneous, and that operating conditions are immediately reached. More specifically, by immediate, it is generally meant a time of one second or less, for example of approximately one second, in particular a time of one second.

Advantageously, the first fluid phase and the second fluid phase may be independently selected from liquid phases (including ionic liquids or deep eutectic solvents), gaseous phases, and supercritical phases.

This is one of the unexpected additional advantages of the method of the invention in that it can be implemented with a wide variety of phases and in particular with at least one supercritical phase.

Advantageously, the first phase may be a liquid phase, and the second phase may be a liquid phase or a supercritical phase, or vice versa. In other words, the first phase and the second phase may be liquid phases, or they may be a liquid phase and a supercritical phase. In short, the first phase may be a liquid phase and the second phase a liquid phase, or the first phase may be a liquid phase and the second phase a supercritical phase, or the first phase may be a supercritical phase and the second phase may be a liquid phase.

The transfer of a solute from one of the phases into the other phase is then generally carried out.

The fact that the method of the invention may be implemented with a supercritical phase is totally surprising and greatly broadens the range of applications of the method of the invention.

In one embodiment, advantageously, the first phase may be a liquid phase containing a solute and the second phase may be a liquid phase containing an extraction solvent for the solute or a supercritical phase acting as an extraction solvent for the solute, and at the end of step a) a liquid phase is recovered called a solute-depleted raffinate, and at the end of step b) a liquid phase is recovered called a solute-enriched extract or a supercritical phase is recovered called a solute-enriched extract; or else the first phase may be a liquid phase containing an extraction solvent for a solute or a supercritical phase acting as an extraction solvent for a solute, and the second phase may be a liquid phase containing the solute, and at the end of step a), a liquid phase is recovered called a solute-enriched extract or a supercritical phase is recovered called solute-enriched extract, and at the end of step b) a liquid phase is recovered called solute-depleted raffinate.

In said embodiment, the supercritical phase acting as extraction solvent for the solute may consist of a pure fluid in the supercritical state, or else it may comprise said fluid in the supercritical state and one or more cosolvent(s), the phase formed by the fluid and the cosolvent(s) generally being in the supercritical state.

In another embodiment, advantageously, the first phase may be a supercritical phase containing a solute, and the second phase may be a liquid phase containing an extraction solvent for the solute, and at the end of step a) a supercritical phase is thus recovered called solute-depleted raffinate, and at the end of step b) a liquid phase is recovered called solute-enriched extract; or the first phase may be a liquid phase containing an extraction solvent for a solute and the second phase may be a supercritical phase containing a solute, and a liquid phase called solute-enriched extract is thus recovered at the end of step a) and a supercritical phase called solute-depleted raffinate is recovered at the end of step b).

In such an embodiment, the supercritical phase containing a solute may consist of a pure fluid in the supercritical state and one or more solute(s), the phase formed by the fluid and the solute(s) generally being in the supercritical state.

Advantageously, for all embodiments, the supercritical fluid may be selected from among carbon dioxide CO₂; sulfur hexafluoride; nitrous oxide N₂O; linear or branched alkanes, preferably linear or branched alkanes having 1 to 10 carbon atoms, in particular having 1 to 5 carbon atoms such as methane, propanes, butanes, and pentanes; cyclic alkanes, preferably cyclic alkanes having 3 to 10 carbon atoms; linear or branched alkenes, preferably linear or branched alkenes having 2 to 10 carbon atoms, in particular 2 to 5 carbon atoms such as ethylene and propylene; alcohols, preferably aliphatic alcohols having 1 to 5 carbon atoms such as methanol, ethanol, and butanols; and mixtures thereof; in particular, the fluid may be selected from mixtures of carbon dioxide CO₂ and at least one other fluid selected from the fluids listed above.

The preferred fluid is carbon dioxide CO₂.

Carbon dioxide particularly has the advantage of being relatively easy to use since it is cheap, non-toxic, non-flammable and has easily accessible critical conditions (critical pressure Pc of 7.3 MPa and critical temperature Tc of 31.1° C.).

Advantageously, the cosolvent may be selected from among water; aqueous solutions; alcohols, preferably aliphatic alcohols having 1 to 5 carbon atoms such as methanol, ethanol, and butanols; ketones, preferably linear or branched ketones having 3 to 10 carbon atoms such as acetone or methyl ethyl ketone, or cyclic ketones; terpenes; hydrofluoroethers; cyclohexanes; and the mixtures thereof.

Advantageously, said aqueous solutions may be selected from detergent solutions such as anionic and/or cationic surfactants; solutions of complexing agents or chelating agents; and mixtures thereof.

Advantageously, the cosolvent may be added to the fluid in an amount of 0.01 to 30 weight %, preferably in an amount of 1 to 10 weight %.

Or else, the first fluid phase may be a liquid phase and the second fluid phase may be a gas phase, or vice versa, and a compound of one of the phases is transferred to the other phase.

Advantageously, the apparatus of the type for Centrifugal Partition Chromatography (CPC) apparatus type may comprise from 100 to 2000 cells.

The cells may be symmetrical or asymmetrical.

Preferably, according to the invention, and due to the fact that an alternation of steps a) and b) is carried out, namely notably an alternation of ascending and descending modes, contrary to chromatography methods, the cells are symmetrical.

Each of the cells may be divided into several sub-cells, for example, into two or three “sub-cells”, connected together by a channel.

Advantageously, the cells are connected to each other by a single channel. More specifically, two consecutive cells of the plurality of cells of the device are connected by one single and unique channel, which simplifies the manufacture of the device and allows the use of a CPC apparatus in a totally new mode, namely a two-fluid countercurrent extraction.

Advantageously, the succession of steps a) and b) may be repeated as many times as necessary to achieve treatment of an entire volume of a feed phase, for example a feed phase from which extraction of the solute is sought.

Preferably, the succession of steps a) and b) is repeated from 1 to 300,000 times, more preferably from 1 to 100,000 times, better from 1 to 10,000 times, still better from 1 to 1,000 times.

Advantageously, the time length of step a) can be from 10 seconds to 120 seconds, preferably from 30 to 60 seconds and the time length of step b) can be from 10 seconds to 120 seconds, preferably from 30 to 60 seconds.

Preferably, the time length of step a) is equal to the time length of step b).

This time length, also called sequence time, has a major impact on the number of theoretical plates NTP generated by the column. The shorter the sequence time the greater the increase in NTP.

The method of the invention differs fundamentally from the prior art methods first in that it uses a Centrifugal Partition Chromatography (CPC) apparatus comprising a plurality of cells to perform continuous exchange of material by countercurrent contacting between a first fluid phase and a second fluid phase that are not fully miscible.

Centrifugal Partition Chromatography (CPC) apparatuses are known apparatuses, but up until now have only been used to perform separations of several solutes based on the principle of chromatography. The use of these CPC apparatuses to perform continuous countercurrent exchange of material between a first fluid phase and a second fluid phase that are not fully miscible has never been described or suggested in the prior art and is totally surprising.

In particular, the use of CPC apparatuses to perform a liquid/liquid extraction operation i.e. a continuous exchange of material of a solute in countercurrent between a first fluid phase and a second fluid phase that are not fully miscible has never been described or suggested in the prior art and is totally surprising.

As already indicated above, the method of the invention (since, surprisingly, continuous countercurrent exchange of material of a solute between only a first fluid phase and a second fluid phase is performed, and not the separation of the constituents of a third phase) is further fundamentally characterized by the fact that only and solely the two liquid phases placed in countercurrent contact are fed into the single apparatus (column) of CPC apparatus (column) type used in the method of the invention and by the fact that no other phase, such as a feed of which the constituents should be separated, is fed into the apparatus of CPC apparatus type such as is the case in document FR-A1-2856933; this is because, in the invention, no separation by chromatographic effect is carried out but rather, in an original manner, a continuous countercurrent exchange of material (in other words, an extraction operation) between a first fluid phase and a second fluid phase.

Indeed, because, according to the invention, it is a continuous exchange of material that is carried out by countercurrent contact between a first fluid phase and a second fluid phase that are not fully, completely, miscible, and not the separation of several constituents such as solutes present in a third phase based on the principle of chromatography; only and solely the two fluid phases brought into countercurrent contact are fed into the single apparatus (column) of CPC apparatus (column) type used in the method of the invention, and no other phase such as a feed of which the constituents are to be separated, is fed into the apparatus.

The method of the invention is also fundamentally different from the methods of the prior art in that it comprises a specific sequence of specific steps a) and b) which follow after one another in rapid succession, and in that these steps a) and b) are repeated. Said specific sequence of specific steps and their repetition has never been described or suggested in the prior art.

The method of the invention consists of using a Centrifugal Partition Chromatography (CPC) apparatus in original manner by very quickly reversing of the mobile phase and the stationary phase to achieve a true continuous countercurrent flow (in the generally accepted meaning of the term countercurrent, in particular in the field of liquid-liquid extraction, and not in the ill-suited meaning given to this term in the field of chromatography) of the first fluid phase and second fluid phase.

In other words, according to the invention, a continuous countercurrent exchange of material between a first fluid phase and a second fluid phase is performed by cyclically performing a rapid succession of steps a) and b), repeated, in a CPC apparatus, in particular a rapid succession of an ascending mode and a descending mode, repeated.

In chromatography, CPC apparatus are used either in ascending mode or descending mode, and the immediate, rapid succession of an ascending mode and a descending mode, repeated, is not performed.

In the method of the invention, notably, a conventional apparatus for Centrifugal Partition Chromatography (CPC), e.g. a standard, commercially available CPC apparatus is thus converted into a continuously operating countercurrent liquid-liquid contactor thereby enabling the extraction and purification of liquid mixtures, using an immiscible (or partially miscible) liquid solvent as separating agent.

An apparatus specifically designed and constructed to operate according to the principle of the method according of the invention, and not a standard CPC apparatus, may also be used.

In particular, the method according to the invention differs fundamentally from the method subject of FR-A1-2956933, in that the method of the invention is a continuous exchange of material method whereas the method in FR-A1-2956933 is a method for separating the constituents of a liquid feedstock.

As a result, the method according to the invention does not comprise, as the method of FR-A1-2956933, a step of injecting an additional phase, namely a feed comprising at least two constituents to be separated, at an intermediate point of a centrifugal liquid-liquid chromatography column, in other words at a point located between the ends of the chromatographic column.

In document FR-A1-2956933, the feed may even be injected at an intermediate point on the conduit connecting two drums, rotors, whereas the method of the invention only uses a single apparatus of the CPC apparatus type.

Additionally, in the method of the invention, only and solely the two fluid phases placed in countercurrent contact are fed into the single apparatus (column) of CPC apparatus (column) type used in the method of the invention, and no other phase such as a feed to be separated is fed into the apparatus of CPC apparatus type used in the method of the invention.

The apparatus of CPC apparatus type used in the method of the invention does not comprise any inlet(s) other than the two inlets for each of the contacted fluid phases, in particular at an intermediate point, in particular fora feed of which the constituents are to be separated as is the case in FR-A1-2856933.

The man skilled in the art is in no way prompted to apply the method described in FR-A1-2856933, not to separate constituents of a feed, but to perform continuous exchange of material between two phases and only two phases without another phase namely, a feed is fed into the CPC device.

The remarks and conclusions set forth above with respect to FR-A1-2856933 also apply to the document by Johannes Goll which cites FR-A1-2856933.

In addition, the method of the invention differs even further from the method and device in the document by Johannes Goll since, in the document by Johannes Goll, two columns are used instead of a single apparatus.

The remarks and conclusions set forth above with respect to FR-A1-2856933 and the document by Johannes Goll also apply to EP-A1-3409339 which cites FR-A1-2856933.

The method of the invention also differs even further from the method and device of EP-A1-3409339 because in EP-A1-3409339 two columns are used instead of a single apparatus.

The method of the invention does not have the drawbacks, defects, limitations and disadvantages of the prior art methods, especially as described above, in particular, and it provides a solution to the problems that arose in the prior art methods, in particularly for known liquid-liquid extraction methods. The method of the invention has a unique combination of advantages compared to prior art methods and in particular compared to prior art liquid-liquid extraction methods, namely:
(1) It is satisfactorily able to treat so-called “difficult” liquid phases, i.e. phases with small differences in density, or which exhibit foaming phenomena.

The method of the invention makes it possible in particular to treat aqueous two-phase systems.

Extraction systems with two aqueous phases consist mainly of water with added polymers and/or salts, for example. These two aqueous phases are non-miscible and allow phase separation on settling.
(2) It is very easy to implement, with, in particular, very short start-up times and very good operating stability, allowing operation without special monitoring and very easy installation in a workshop.
(3) The method of the invention affords the possible use of a large theoretical plate number.
(4) The method of the invention allows the treatment of low feed rates, for example lower than 30 L/h, even lower than 20 L/h, or even lower than 10 L/h, for which gravity columns are not suitable.

The theoretical plate number obtained with the method of the invention is generally greater than or equal to 5, even greater than or equal to 20, and even greater than or equal to 30, and it can reach up to one or several hundred of theoretical plates.

This very large number of theoretical plates means that very high separation efficiency is obtained with the method of the invention.

In the best-case scenario, each elementary cell of the CPC apparatus maybe considered to be a theoretical plate.

This very large number of theoretical plates is achieved with a single apparatus, whereas in the methods of the prior art it is necessary to use several apparatuses in series to treat equivalent flow rates and to obtain such a high number of theoretical plates with associated costs and space requirements.

The volume taken up by the single apparatus used in the method of the invention is much smaller than that required by apparatuses used in existing technologies treating equivalent flow rates.

The apparatus used in the method of the invention is also advantageous compared to gravity columns which cannot handle low feed rates due to wall effects.

Moreover, whether compared to methods that use columns or to methods that use gravity mixer-settlers, the method of the invention allows for much faster start-up and steady-state operation, generally less than one minute, whereas the other two methods have start-up times of longer than 15 minutes and rather more of about one hour.

The possibility, in the method of the invention to use a very high theoretical plate large number gives access, for example, to the following two applications of the method of the invention that cannot be implemented by current technologies or only with difficulty.

First application: For conventional extractions (it is specified that, by “conventional extractions”, it is meant product recovery rates of less than 99% in the extraction solvent).

For these conventional extractions, it is possible with the method of the invention to use a solvent ratio very close to the theoretical minimum value of the solvent ratio. Conventionally, a solvent ratio of 1.5 to 3 times this theoretical minimum value is used in known methods, since lower ratios require the use of a large number of theoretical plates which is unreasonable with conventional technologies.

The large number of theoretical plates potentially accessible with the method of the invention therefore removes this limitation and allows to envisage operations with solvent ratios very close to the theoretical minimum.

With the method of the invention, it is therefore possible to reduce the solvent ratio by approaching the theoretical minimum value. This leads to reduced operating costs since costs related to the purchase of the solvent, regeneration of the solvent, and pumping are decreased.

Second application: For “ultra-recovery” of the solute.

The method of the invention may be used for “ultra-recovery” when a very high recovery rate of the solute (i.e. >99 weight %) must be obtained.

In this case, the theory of transfer of material between phases indicates that a very high theoretical plate number will be necessary to obtain the desired purity.

This configuration corresponds to two practical cases:

(1) It is desired to remove an impurity and to obtain an ultra-pure raffinate with respect to this impurity.

(2) It is desired to extract a diluted solute with very high added value and its recovery rate must be very high.

This second application is of great interest, in particular in the context of recovery of high added-value species, for example in biotechnology or hydrometallurgy.

To summarise, it may be said that the method of the invention particularly allows the performing of exchange with a high NTP and/or the use of low flow rates of extraction solvents.

Another important advantage of the method of the invention, found in any type of application, is the ability to treat all kinds of systems and in particular “difficult” liquid phases for example having a small difference in density between the phases, and/or a surfactant effect inducing low interfacial tension between the liquid phases causing risks of emulsification.

It may be said that the method of the invention surprisingly combines the advantages of centrifugal extractor methods and multi-stage column methods with a large number of stages.

The invention further relates to a device for carrying out the method of the invention, as described in the foregoing, comprising:
An apparatus of Centrifugal Partition Chromatography (CPC) apparatus type;
a first tank containing the first fluid phase;
a second tank containing the second fluid phase;
a first pipe provided with a first pump and a first valve, connecting the first tank to a first inlet of the apparatus of Centrifugal Partition Chromatography apparatus type;
a second pipe provided with a second pump and a second valve, connecting the second tank to a second inlet of the apparatus of Centrifugal Partition Chromatography apparatus type; and
a third pipe provided with a third valve, connecting the second inlet of the apparatus of Centrifugal Partition Chromatography apparatus type to a tank intended to collect the first fluid phase, such as a liquid phase called raffinate, that has passed through the apparatus of Centrifugal Partition Chromatography apparatus type;
a fourth pipe provided with a fourth valve, connecting the first inlet of the apparatus of Centrifugal Partitioning Chromatography apparatus type to a tank intended to collect the second fluid phase, such as a liquid phase called extract, that has passed through the apparatus of Centrifugal Partitioning Chromatography apparatus type;
control means to actuate the opening and closing of the valves, to actuate the operation and stopping of the pumps, to synchronize the operation of the pumps and valves, to control the opening and closing times of the valves and the operation and stopping times of the pumps.

The device of the invention comprises an apparatus of Centrifugal Partition Chromatography apparatus type (single) which is equipped with a specific assembly of reservoirs, pipes, valves, pumps and control means, which has never been described or suggested in the prior art, and which converts this apparatus of Centrifugal Partition Chromatography apparatus type, designed to perform chromatographic separations, to a device able to implement the method of the invention, namely able to carry out an exchange of material by continuous countercurrent contacting between a first fluid phase and a second fluid phase, by carrying out cyclically repeated of steps a) and steps b) in this apparatus, in particular a repeated ascending mode and descending mode or a repeated descending mode and ascending mode

All the remarks set forth above with respect to the method of the invention also apply mutatis mutandis to the device of the invention.

The apparatus of Centrifugal Partition Chromatography (CPC) apparatus type of the device according to the invention, comprises only two inlets for feeding phases into the apparatus, namely a first inlet through which the first fluid phase is fed into the apparatus, and a second inlet through which the second fluid phase is fed into the apparatus.

It is to be noted that the apparatus of Centrifugal Partition Chromatography (CPC) apparatus type could also be termed a column of Centrifugal Partition Chromatography column type.

The apparatus (column) of CPC apparatus (column) type used in the invention generally comprises only two inlets for feeding phases into the apparatus, namely a first inlet through which the first fluid phase is fed into the apparatus and a second inlet through which the second fluid phase is fed into the apparatus, and if the apparatus optionally also comprises one or more other inlets, these inlets are not used to feed one or more other phase(s) (i.e. other than the first fluid phase and second fluid phase) into the apparatus.

The first inlet is preferably located at a first end of the apparatus (column) and the second inlet is preferably located at a second end of the column.

Only the two fluid phases placed in countercurrent contact are fed into the single apparatus (column) of CPC apparatus (column) type, used in the method of the invention, and no other phase such as a feedstock is additionally fed into the apparatus of CPC apparatus type.

The apparatus of CPC apparatus type used in the device of the invention does not comprise, in addition to the two inlets for each of the fluid phases brought into contact, any other inlet(s), in particular at an intermediate point, in particular for a feed of which the constituents are to be separated as is the case in document FR-A1-2856933 since, according to the invention, no separation is performed.

In particular, contrary to the device in FR-A1-2856933, the device of the invention does not comprise a pump P1 for injecting the sample, feed at an intermediate point of the column (FIGS. 1, 2), or even on the conduit separating two drums, rotors.

The remarks and conclusions formulated above with regard to document FR-A1-2856933 also apply to the article by Johannes Goll which cites FR-A1-2856933.

Moreover, the claimed device differs even further from the device of the document by Johannes Goll since, instead of a single apparatus, these are two columns which are used in the document by Johannes Goll.

The remarks and conclusions set forth above with respect to FR-A1-2856933 and the Johannes Goll document also apply to document EP-A1-3409339 which cites FR-A1-2856933.

Moreover, the claimed device differs even further from the device of EP-A1-3409339 because, in document EP-A1_3409339, instead of a single apparatus, these are two columns that are used.

The device of the invention inherently has all the advantages of the method it implements and which have already been set forth above.

Advantageously, the control means comprise a programmable controller which allows alternating and timed operation between:
a first mode, for example an ascending mode, preferably of determined time length, in which the first pump is in operation, the first valve is open, and the third valve is open, whilst the second pump is stopped, the second valve is closed, and the fourth valve is closed and;
a second mode, for example a descending mode, preferably of determined time length, in which the second pump is in operation, the second valve is open and the fourth valve is open, whilst the first pump is stopped, the first valve is closed, and the third valve is closed.

Advantageously, the third and/or fourth pipes are provided with detection and/or analysis means such as UV, IR, or Raman detectors.

With these detection and/or analysis means it is possible, in particular, to analyse the composition of the liquid phases in these pipes, for example to continuously monitor the solute concentration in these liquid phases.

Advantageously, the cells are connected to each other by a single channel. More specifically, two consecutive cells of the plurality of cells of the apparatus are connected by a single channel, which simplifies the apparatus and lowers costs.

The invention will be better understood upon reading the following detailed description of embodiments of the device and method of the invention given with reference to the appended drawings.

### BRIEF DESCRIPTION OF THE DRAWINGS

FIG. 1 is a schematic view illustrating the principle of Centrifugal Partition Chromatography (CPC) in ascending mode, and of the first step a) of the method of the invention, called the ascending mode step.

FIG. 2 is a schematic view illustrating the principle of the second step b) of the method of the invention, called the descending mode step.

FIG. 3 is a schematic view of one embodiment of the device of the invention, for carrying out the method of the invention.

FIGS. 4A and 4B are a schematic view of another embodiment of the device of the invention for carrying out the method of the invention.

FIGS. 4A and 4B also illustrate operation in descending mode (FIG. 4A) and in ascending mode (FIG. 4B) at steps a) and b) of the device of these Figures, for carrying out the method of the invention.

### DETAILED DESCRIPTION OF PARTICULAR EMBODIMENTS

In the following detailed description, embodiments of the device for carrying out the method of the invention are first described in detail, and the manner in which the method of the invention is carried out in these devices.

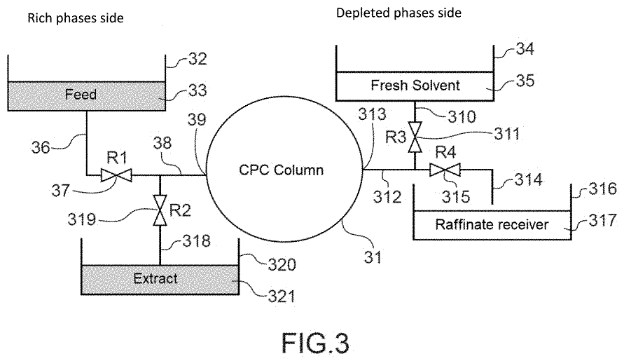

One embodiment of the device of the invention, for implementing, carrying out, the method of the invention, is described in a simplified manner in FIG. 3.

This device comprises:
an apparatus of Centrifugal Partition Chromatography apparatus type such as a CPC column (31);
a first tank (32) containing the first fluid phase (33), for example a liquid phase called feed phase or (solute)-rich phase which is for example an aqueous liquid phase, such as an aqueous solution containing a compound to be extracted, a solute such as a pollutant;
a second tank (34) containing the second fluid phase (35), for example a liquid phase called solvent phase;
a first pipe (36), equipped with a first pump (not shown) and a first valve R1 (37), connecting via pipe (38) the first tank (32) to a first inlet (39) of the apparatus of Centrifugal Partition Chromatography apparatus type (31);
a second pipe (310), provided with a second pump (not shown) and a second valve R3 (311), connecting via pipe (312) the second tank (34) to a second inlet (313) of the apparatus of Centrifugal Partition Chromatography apparatus type (31);
a third pipe (314), provided with a third valve R4 (315), connecting via pipe (312) the second inlet (313) of the apparatus of Centrifugal Partition Chromatography apparatus type (31) to a tank (316) intended to collect the first fluid phase such as a liquid phase called raffinate (317) that has passed through the apparatus of Centrifugal Partition Chromatography apparatus type (31). The raffinate is the feed phase that has been purified of the compound to be extracted i.e. of the solute, from which the solute has been extracted;
a fourth pipe (318), provided with a fourth valve R2 (319), connecting via pipe (38) the first inlet (39) of the apparatus of Centrifugal Partitioning Chromatography apparatus type (31) to a tank (320) intended to collect the second fluid phase such as a liquid phase called extract (321) that has passed through the apparatus of Centrifugal Partitioning Chromatography apparatus type (31). The extract is the solvent phase enriched with the product to be extracted i.e. solute.

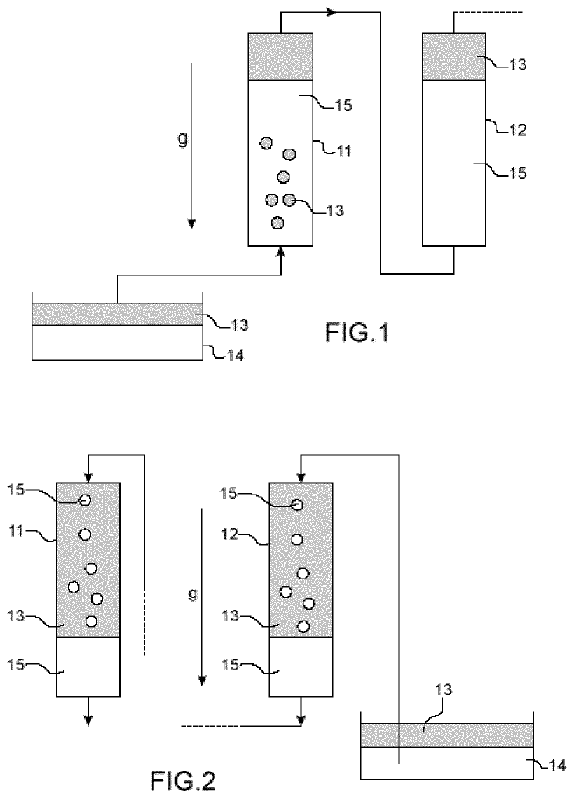

In the device of the invention, described in FIG. 2, a CPC contactor, apparatus is equipped with a set of valves R1 (37), R2 (319), R3 (311), R4 (315) controlled automatically to provide cyclic countercurrent operation of the CPC-type apparatus (31).

In this example of operation, the first liquid phase i.e. the solute-rich feed phase, has greater density than the second liquid phase i.e. the fresh solvent phase. The operation of the apparatus allows to cyclically reproduce the ascending mode in which the mobile phase is the second fluid phase, and the descending mode in which the mobile phase is the first fluid phase.

In practice, in ascending mode, valves R1 and R4 are closed and valves R2 and R3 are open, whereas in the descending mode, valves R2 and R3 are closed and valves R1 and R4 are open.

In the case when the feed phase has a lower density than the solvent phase, the operation is reversed: in the ascending mode valves R1 and R4 are open and valves R2 and R3 are closed, whereas in the descending mode valves R2 and R3 are open and valves R1 and R4 are closed.

The originality of the invention lies in the control of the cyclic operation (in particular cycle time) to reproduce counter-current operation with the desired theoretical plate number for a given separation.

A programmable controller (not shown) is used to drive the switching of the valves and to synchronize the operation of the pumps and valves.

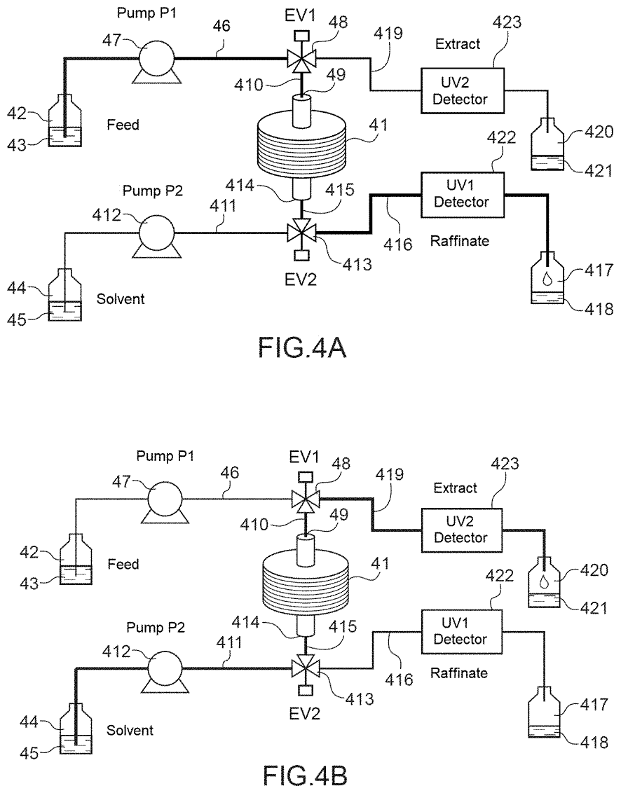

Another embodiment of the device of the invention for implementing the method of the invention, is described in simplified manner in FIG. 4.

In this embodiment, it is to be understood that the feed phase has greater density than the solvent phase.

This device comprises:
an apparatus of Centrifugal Partition Chromatography apparatus type, also called CPC contactor (41);
a first tank (42) containing the first fluid phase (43), for example a liquid phase called feed phase F or (solutes)-rich phase or heavy phase which is for example an aqueous liquid phase such as an aqueous solution containing a compound to be extracted, a solute, such as a pollutant;
a second tank (44) containing the second fluid phase (45), for example a liquid phase called solvent phase S′ or (solutes)-depleted phase or light phase, this phase may be fresh solvent for example to extract the solutes from the feed phase;
a first line (46), equipped with a first pump P1 (47), connecting the first tank (42) to a first three-way valve EV1 (48). The first three-way valve (48) is connected to a first inlet (49) of the of Centrifugal Partition Chromatography apparatus (41) by a pipe (410);
a second pipe (411), equipped with a second pump P2 (412), connecting the second tank (44) to a second three-way valve EV1 (413). The three-way valve (413) is connected to a second inlet (414) of the Centrifugal Partition Chromatography apparatus (41) by a pipe (415);
a third pipe (416) connecting the second three-way valve (413) to a tank (417) intended to collect the first fluid phase such as a liquid phase called raffinate (418), that has passed through the Centrifugal Partition Chromatography apparatus (41). The raffinate R is the feed phase which has been purified of the compound to be extracted, i.e. the solute.
a fourth pipe (419) connecting the first three-way valve (48) to a tank (420) intended to collect the second fluid phase, such as a liquid phase called extract E (421) that has passed through the Centrifugal Partition Chromatography apparatus (41). The extract (421) is the solvent phase enriched with the product to be extracted, i.e. solute.

Specific detectors, for example Raman, IR, or UV detectors (UV1 detector (422)), may be provided on the pipes (416) (UV1 detector (422)) and (419) (UV2 detector (423)) for continuous in-line analysis of solute concentration in the raffinate R and in the extract E.

A Programmable Logic Controller PLC (not shown) is used to control switching of the valves and to synchronize the operation of the pumps and of these valves.

The implementation of the method of the invention with the device shown in FIGS. 4A and 4B will now be described.

This implementation is described by way of example, particularly with respect to the implemented phases, and the man skilled in the art will easily be able to adapt the following description to any phase irrespective of type.

In FIG. 4A, circulation in descending mode takes place in the bold lines.

In FIG. 4B, the circulation in ascending mode takes place in the bold lines.
the solute B of interest is dissolved in the feed phase F (43) found in the tank (42);
pump P1 (47) allows to send the Feed F phase (43) into the CPC contactor (41);
pump P2 (412) allows to send the extraction solvent S′ (45) from the tank (44) to the CPC contactor (41);
at the outlet of the CPC contactor, the Feed F which has been depleted of solute B becomes the Raffinate phase R, and the Extraction Solvent S′ which has been enriched with solute B becomes the Extract phase E. The Raffinate phase R leaves the CPC contactor (41) through inlet (414), then through pipe (415), valve (413) and pipe (416). The extracted phase leaves the CPC contactor (41) through inlet (49), pipe (410), valve (48), and pipe (419);
the CPC contactor (41) contains a number of cells Y. By convention, “Start of contactor” shall designate that part of the contactor located on the inlet side of the Feed phase (49) and on the outlet side of the Extract phase (49) (on top in FIGS. 4A and 4B).
“End of contactor” shall designate that part of the contactor located on the inlet side of the Solvent phase (414), on the outlet side of the Raffinate phase (414) (At the bottom in FIGS. 4A and 4B).
on start-up, the CPC contactor (41) is first filled with extraction solvent S′ by pump P2 (412). The contactor is rotated to the desired set value, and pump P1 (47) is then used to fill the CPC contactor with a given amount of feed phase (43) containing no solute. Typically, the man skilled in the art can adjust the ratio of solvent and feed phases in the contactor by acting on the rotation speed and the flow rate of feed phase used;
the quantity of solvent S′ expelled due to filling of the CPC contactor (41) with the feed phase can be collected in a specific receiver or else in the main receiver Extract (tank 420).

Hydrodynamic equilibration of the CPC contactor is thus achieved.
once the CPC contactor is stabilised, programming of the PLC is triggered.
pump P1 (47) sends then a volume F1 of phase F (43) (containing the solute) over a given time (denoted Tcycle1) at the beginning (49) of the CPC contactor. Phase F is therefore the mobile phase feeding the CPC contactor.
having regard to the densities in this example of implementation, this first cycle takes place in descending mode.

Simultaneously, valve EV1 (48) is positioned to allow the above-mentioned volume F1 to pass into the CPC contactor (41) through pipe (410), and valve EV2 (413) is positioned to send through lines (415) and (416) a phase of volume F1′, contained at the end of the CPC contactor, which is equivalent (or almost equivalent) to volume F1. This phase of volume F1′ is therefore expelled from the CPC contactor (41) towards the Raffinate receiver (417) via pipes (415) and (416).

At the beginning of the contactor, a feed volume F1 containing solute therefore passes through a number X1 of cells of the CPC contactor (41).
After the cycle time Tcycle1 is completed, pump P1 (47) is stopped and pump P2 (412) is actuated. This pump P2 (412) sends then a given volume S1 of extraction solvent S′ (45) from the tank (44) to the end of the CPC contactor during a cycle time Tcycle1.

Simultaneously, valve EV2 (413) is positioned to allow the passing of a volume equivalent (or quasi-equivalent) to volume S1 in the CPC contactor (41), and valve EV1 (48) is positioned to allow the passing of a volume of solvent phase S1′ contained at the beginning of the CPC contactor (41), equivalent (or quasi-equivalent) to volume S1. This volume of solvent phase is thus expelled from the CPC contactor (41) towards the Extract receiver (420) via pipes (410) and (419).
the solvent phase S′ then becomes the mobile phase in the CPC device and the feed phase becomes the stationary phase. The solvent volume S1 (421) expelled from the CPC contactor contains solute that has been extracted from the feed phase contained in the X1 cells.

On this second cycle, the device therefore operates in ascending mode, i.e. with the mobile phase lighter than the stationary phase.
once T′cycle is completed, the operating cycle resumes under the conditions defined during Tcycle1 and the feed phase again becomes the mobile phase. Pump P1 (47) then fills X2 cells of the CPC with feed phase F (X2 may be equal to or different from X1 according to PLC programming), repelling towards the end of the CPC contactor the feed phase already contained in the X1 cells of the CPC contactor and which underwent extraction during Tcycle1;
this alternating operation allows simulation of a countercurrent flow of phases F and S′. This alternating operation takes place until the entire feed volume F is treated;
modelling the behavior of this device is possible for the man skilled in the art. This modelling allows the controller to be programmed so as to obtain the desired results;
the influential input parameters which can be fed into the program of the controller are in particular: the volumes of F and S′ successively sent by the pumps, the operating times Tcycle and T′cycle (with of the possibility of having variable times during an operation), rotation speed, the geometry and the number of cells, the contactor volume, the initial stationary phase/mobile phase ratios, the system thermodynamics (partition coefficient of the solute, density and viscosity of the phases, interfacial tension . . . );
these input parameters and the very operating principle of the method of the invention allow the obtaining of a material transfer phenomenon, the result of which is extraction of the solute from the feed phase to the solvent phase;
the input parameters and operation of the CPC contactor then define a theoretical plate number (TPN) value for extraction, a purification rate of solute from the Feed phase, and a solute extraction rate of the Solvent phase;
in another operating configuration of the invention, the feed phase may be lighter than the solvent phase. The principle of the invention remains valid except that the feed phase is sent in ascending mode when it becomes the mobile phase and the solvent phase is sent in descending mode when it becomes the mobile phase;
in another operating configuration of the invention, the CPC contactor may be initially thermodynamically equilibrated using a feed phase F containing solute.

The invention will now be described with reference to the following illustrative and non-limiting examples.

### EXAMPLES

In the following Examples 1 to 6, the implementation of the method of the invention is described, with an installation according to the invention.

The installation used in the examples is similar to that described in FIGS. 1 and 2. This installation comprises a system of two G1/8 valves available from Bürkert®, Germany, controlled by a PLC (driven by Labview®). These valves are placed as close as possible to the rotary seals of the CPC apparatus.

When one of the valves is in the closed position, the other is in the open position.

Two AP-100 pumps, available from Armen®, France, allows the arrival of the feed and of the solvent into the CPC contactor.

The CPC contactor, CPC apparatus, is an EPC 300 column available from Kromaton®, France, having a volume of 280 mL and containing 231 asymmetric cells.

The raffinate and extract are recovered at the end of each test and assayed by UV spectrophotometry at 280 nm, using a Jasco® V630 dual beam spectrophotometer.

### Examples 1, 2 and 3

In these examples, the tested phase system was the following: acetone (solute), heptane and water.

The feed phase F was the heptane phase containing the acetone to be extracted.

The extraction solvent S′ (solvent phase) was water.

The operating conditions were as follows:
Rotation speed N of the CPC apparatus=800 rpm;
F=48 mL/min of heptane at a concentration of 1.3 weight % acetone; and
S′=12 mL/min of water containing no acetone.

The column, CPC contactor, was first hydrodynamically equilibrated with this liquid phase system.

At equilibrium, 60% of the CPC contactor volume was occupied by the aqueous stationary phase and 40% by the heptane phase, i.e. a retention of 60%.

The phases system described above was tested for 3 different cycle times, T Cycle, but each time with T cycle=T′ cycle.

These cycle times T Cycle were respectively 120 s., 60 s., and 30 s., for Examples 1, 2, and 3.

Under the experimental conditions used, the acetone partition coefficient K123 (i.e. the partition coefficient for Examples 1, 2, and 3) between the organic phase (feed phase) and the aqueous phase (solvent phase) was considered to be constant.

This partition coefficient Kin is given by the formula below (Foucault, A. P. Chromatographic Science Series In Centrifugal Partition Chromatography; Marcel Dekker: New York, 1995; Vol. 68):

$${K}_{123} = 4 \frac{kg acetone \text{/} L feed phase}{kg acetone \text{/} L solvent phase}$$

The results obtained are grouped together in following Table I:

| | | | | | | Solute extraction | |
|---|---|---|---|---|---|---|---|
| | | | | | | rate by weight | |
| | | | | XBF | XBR | (1 - XBR/XBF) | |
| F (mL/min) | S (mL/min) | T Cycle(s) | T′ Cycle(s) | (weight %) | (weight %) | (weight %) | NTP |
| 48 | 12 | 120 | 120 | 1.3 | 0.07 | 94.62% | 17.6 |
| 48 | 12 | 60 | 60 | 1.3 | 0.06 | 95.38% | 20.7 |
| 48 | 12 | 30 | 30 | 1.3 | 0.03 | 97.69% | 42.3 |

The flow rates of the two phases were selected for operation with a separation factor ε=K·S/F=1, a conventional operating configuration.

The NTP value was calculated based on liquid/liquid extraction theory discussed below and with a separation factor of 1, leading to the following simplified formula TPN=(X_{F}−Xₙ)/Xₙ.

The experimental results illustrate the proper functioning of the method of the invention.

The CPC contactor allowed between 17 and 42 theoretical extraction plates to be achieved (solute extraction rate with respect to the feed of between 94 weight % and 97 weight %). The use of short cycle times enabled the contactor to operate under conditions increasingly closer to a true continuous countercurrent. Use of a CPC contactor having more cells would allow even higher TPN values to be obtained.

### Examples 4, 5 and 6

In these examples, the phase system tested was the following: acetone (solute), heptane and water. In these examples, the feed phase F consists now of the water phase which therefore contains acetone, and the extraction solvent S′ (solvent phase) was pure heptane.

The operating conditions were the following:
rotation speed of N of the CPC device=800 rpm,
F=12 mL/min of water containing acetone; and
S′=48 mL/min of heptane containing no acetone.

The CPC contactor was hydrodynamically equilibrated with this liquid phases system.

At equilibrium, the retention obtained was 40%, i.e. 40% of the contactor volume was occupied by the heptane stationary phase.

The phase system described above was tested for 3 different cycle times, T Cycle.

These cycle times, T Cycle, were respectively 120 s., 60 s., and 30 s., for examples 1, 2, and 3.

These cycle times, T Cycle, were respectively 120 s., 60 s., and 30 s., for examples 1, 2, and 3.

In the configuration of these Examples 4, 5, and 6, in which the solvent and feed phases were modified when compared to Examples 1, 2, and 3, the partition coefficient K456 (i.e., partition coefficient for Examples 4, 5, and 6) was now the reverse of that defined above, namely:

$${K}_{456} = 0.25 \frac{kg acetone \text{/} L Feed phase}{kg acetone \text{/} L Solvent phase}$$

To obtain a similar separation configuration, the flow rates were modified to maintain a separation factor E of 1.

The results obtained are grouped together in following Table II:

| | | | | | | Solute extraction | |
|---|---|---|---|---|---|---|---|
| | | | | | | rate by weight | |
| | | | | XBF | XBR | (1 - XBR/XBF) | |
| F (mL/min) | S (mL/min) | T Cycle (s) | T′ Cycle (s) | (weight %) | (weight %) | (weight % ) | NTP |
| 12 | 48 | 120 | 120 | 5.3 | 0.7 | 86.79 | 6.6 |
| 12 | 48 | 60 | 60 | 5.41 | 0.61 | 88.72 | 7.9 |
| 12 | 48 | 30 | 30 | 5.3 | 0.56 | 89.43 | 8.5 |

The NTP value was calculated based on the liquid/liquid extraction theory and with a separation factor of 1, which leads to the following simplified formula TPN=(X_{F}−Xₙ)/Xₙ.

In this case, the CPC contactor allowed between 6 and 8.5 theoretical extraction plates to be obtained (extraction rate of solute in relation to feed of between 86 weight % and 89 weight %).

The results were not as good as those obtained in the previous Examples 1, 2, and 3. The use of short cycle times enabled the contactor to operate under conditions increasingly closer to a continuous countercurrent.

Use of a CPC contactor with more cells would allow higher TPN values to be obtained.

Several hypotheses can be set forth to account for the less good results in this configuration of Examples 4, 5, and 6:

1—the retention of the stationary phase in the second case (heptane) is lower (40% instead of 60%) leading to less good contacting between the phases;

2—the flow of the dispersed droplets in the cells is less favorable in the second case. This difference in flow may be related to the asymmetry of the cells in the device used here.

What is claimed is:

1. A method for continuous exchange of material by countercurrent contacting of a first fluid phase and a second fluid phase that are not fully miscible, wherein contacting is performed in a single apparatus, which is an apparatus of Centrifugal Partition Chromatography (CPC) apparatus type, into which only the first fluid phase and the second fluid phase are fed, excluding any other phase, said apparatus comprising a plurality of cells, with a stationary phase immobilised in each of the cells and a mobile phase passing through the stationary phase, and in that the following steps a), b), and c) are successively carried out:
a) Step at which the mobile phase consists of the first fluid phase, and the stationary phase immobilised in the cells consists of the second fluid phase.
b) Step at which the mobile phase consists of the second fluid phase, and the stationary phase immobilised in the cells consists of the first fluid phase.
c) Repetition of the succession of steps a) and b);
step b) being performed immediately after step a), and step c) being performed immediately after step b).

2. The method according to claim 1 wherein the apparatus, which is an apparatus of Centrifugal Partition Chromatography (CPC) apparatus type, comprises only two inlets for feeding phases into the apparatus, namely a first inlet through which the first fluid phase is fed into the apparatus, and a second inlet through which the second fluid phase is fed into the apparatus, and if the apparatus optionally further comprises one or more other inlet(s), this inlet (these inlets) is (are) not used to feed one or more other phase(s) into the device.

3. The method of claim 1, wherein the density of the first fluid phase is lower than the density of the second fluid phase, and step a) is then a step called step in ascending mode, and step b) is then a step called step in descending mode; or else the density of the first fluid phase is greater than the density of the second fluid phase, and step a) is then a step called step in descending mode, and step b) is then a step in called step in ascending mode.

4. The method according to claim 1, wherein the first fluid phase and the second fluid phase are independently selected from among liquid phases, gaseous phases, and supercritical phases.

5. The method according to claim 1, wherein the first phase is a liquid phase and the second phase is a liquid phase or a supercritical phase, or vice versa.

6. The method according to claim 5, wherein the first phase is a liquid phase containing a solute and the second phase is a liquid phase containing an extraction solvent for the solute or a supercritical phase acting as an extraction solvent for the solute, and at the end of step a) a liquid phase called solute-depleted raffinate is recovered, and at the end of step b) a liquid phase called solute-enriched extract is recovered or a supercritical phase called solute-enriched extract is recovered; or else the first phase is a liquid phase containing a an extraction solvent for a solute or a supercritical phase acting as an extraction solvent for a solute and the second phase is a liquid phase containing the solute, and at the end of step a) a liquid phase called solute-enriched extract is thus recovered or a supercritical phase called solute-enriched extract is thus recovered, and at the end of step b) a liquid phase called solute-depleted raffinate is recovered.

7. The method according to claim 5, wherein the first phase is a supercritical phase containing a solute and the second phase is a liquid phase containing an extraction solvent for the solute, and at the end of step a) a supercritical phase called solute-depleted raffinate is thus recovered, and at the end of step b) a liquid phase called solute-enriched extract is recovered; or else the first phase is a liquid phase containing an extraction solvent for a solute and the second phase is a supercritical phase containing a solute, and at the end of step a) a liquid phase called solute-enriched extract is thus recovered, and at the end of step b), a supercritical phase called solute-depleted raffinate is recovered.

8. The method according to claim 1, wherein the first fluid phase is a liquid phase and the second fluid phase is a gaseous phase, or vice versa, and a compound is transferred from one of the phases into the other phase.

9. The method according to claim 1, wherein the apparatus of Centrifugal Partition Chromatography (CPC) apparatus type comprises from 100 to 2000 cells.

10. The method according to claim 1, wherein the cells are symmetric.

11. The method according to claim 1, wherein each of the cells is divided into several sub-cells, for example two or three sub-cells, connected together via a channel.

12. The method according to claim 1, wherein the succession of steps a) and b) is repeated as many times as necessary to achieve the treatment of an entire volume of a feed phase, for example of a feed phase from which it is sought to extract the solute; preferably the succession of steps a) and b) is repeated from 1 to 300,000 times, more preferably from 1 to 100,000 times, better from 1 to 10,000 times, and still better from 1 to 1,000 times.

13. The method according to claim 1, wherein the time length of step a) is from 10 seconds to 120 seconds, preferably from 30 to 60 seconds and the time length of step b) is from 10 seconds to 120 seconds, preferably from 30 to 60 seconds.

14. The method according to claim 1, wherein the time length of step a) is equal to the time length of step b).

15. A device for carrying out the method according to claim 1, comprising:
an apparatus of Centrifugal Partition Chromatography (CPC) apparatus type (31);
a first tank (32) containing the first fluid phase (33); and
a second tank (34) containing the second fluid phase (35);
a first pipe (36) provided with a first pump, and a first valve (37), connecting the first tank (32) to a first inlet (39) of the apparatus of Centrifugal Partitioning Chromatography apparatus type (31); and
a second pipe (310) provided with a second pump and a second valve (311), connecting the second tank (34) to a second inlet (313) of the apparatus of Centrifugal Partition Chromatography apparatus type (31);
a third pipe (314) provided with a third valve (315), connecting the second inlet (313) of the apparatus of Centrifugal Partition Chromatography apparatus type (31) to a tank (316) intended to collect the first fluid phase, such as a liquid phase called raffinate (317), that has passed through the apparatus of Centrifugal Partition Chromatography apparatus type (31);
a fourth pipe (318) provided with a fourth valve (319), connecting the first inlet (39) of the apparatus of Centrifugal Partition Chromatography apparatus type (31) to a tank (320) intended to collect the second fluid phase, such as a liquid phase called extract (321) that has passed through the apparatus of Centrifugal Partition Chromatography apparatus type (31);
control means to actuate the opening and closing of the valves, to actuate the operation and stopping of the pumps, to synchronize the operation of the pumps and valves, to control the opening and closing times of the valves and the operation and stopping times of the pumps.

16. The device of claim 15, wherein the control means comprise a programmable logic controller that allows alternating and timed operation between:
a first mode, preferably of determined time length, in which the first pump is in operation, the first valve is open, and the third valve is open, whilst the second pump is stopped, the second valve is closed, and the fourth valve is closed and;
a second mode, preferably of determined time length, in which the second pump is in operation, the second valve is open and the fourth valve is open, whilst the first pump is stopped, the first valve is closed, and the third valve is closed.

17. The device according to claim 15, wherein the third and/or fourth pipe are provided with detection and/or analysis means such as UV, IR, or Raman detectors.
